(19) United States
(12) Patent Application Publication
(10) Pub. No.: US 2017/0018183 A1
(43) Pub. Date: Jan. 19, 2017

(54) SYSTEM AND METHOD OF CREATING A DYNAMIC PARKING SPOT

(71) Applicant: Sparkcity.com Ltd., Tel Aviv (IL)

(72) Inventors: Itamar Rosen, Tel Aviv (IL); Haim Yosef Gotlieb, Beitar Illit (IL); Shai Yagur, Tel Aviv (IL)

(73) Assignee: Sparkcity.com Ltd., Tel Aviv (IL)

(21) Appl. No.: 15/058,540

(22) Filed: Mar. 2, 2016

Related U.S. Application Data
(63) Continuation-in-part of application No. PCT/IB2015/056509, filed on Aug. 27, 2015.
Application No. PCT/IB2015/056509 is a continuation-in-part of application No. PCT/IB2015/056512, filed on Aug. 27, 2015.
(60) Provisional application No. 62/042,445, filed on Aug. 27, 2014.

(51) Int. Cl. G08G 1/13; G06Q 10/02

(52) U.S. Cl. CPC G08G 1/13; G06Q 10/02

(57) ABSTRACT

A system including: (a) a reservation server receiving reservation input, parking confirmation input and parking exit input from at least one user client device; and (b) a parking spot status database in communication with the server and configured to assign to each spot in the database a status selected from a group including at least available, reserved and occupied in accord with the inputs received by the server.

### CROSS-REFERENCE TO RELATED APPLICATIONS

This is a Continuation-in-Part of International Patent Application No. PCT/IB2015/056509, filed Aug. 27, 2015, which claims the benefit of U.S. Provisional Patent Application No. 62/042,445, filed Aug. 27, 2014. This is also a Continuation-in-Part of International Patent Application No. PCT/IB2015/056512, filed Aug. 27, 2015, which claims the benefit of U.S. Provisional Patent Application No. 62/042,445, filed Aug. 27, 2014. All of the foregoing applications are incorporated by reference in their entirety herein.

### FIELD OF THE INVENTION

The invention is in the field of parking systems.

### BACKGROUND OF THE INVENTION

Applicant has identified key components in providing a holistic solution to known problems faced both by drivers and by regional authorities such as municipalities and venue managers.

Embodiments of the invention provide tools for municipalities to respond efficiently to changes affecting the urban space, thereby enabling solutions where there are none and reducing the often significant resources required in dealing with these changes (e.g., policing and directing traffic).

Additionally, embodiments of the invention facilitate valid parking, namely, parking that does not violate parking regulations. By facilitating valid parking, embodiments of the invention save an individual driver time and money. Also, by facilitating valid parking, congestion which is caused by uninformed (and thus hesitant) drivers typically slowing down while trying to determine the rules of a parking spot, may be significantly reduced.

Municipal government often finds itself unable to respond efficiently in the face of routine changes as well as special events affecting the urban space (such as traffic congestion, public events and disasters). In many cases, partial or no suitable solutions may be provided to handle these changes. Even when solutions are provided, significant resources of both money and man hours are invested in providing the necessary policing in directing traffic and closing streets, for example.

On a different note, city traffic is hampered by individual drivers competing for available parking spots, often taking longer to park than desired. This can also lead to parking at a location either further away than necessary and/or more expensive than desired. Also, in many cases, drivers are unaware of the rules governing specific parking spots, and inadvertently either violate parking regulations or mistakenly forego a valid parking spot, thereby wasting both time and money, and further adding to the already congested city streets.

### SUMMARY OF THE INVENTION

A broad aspect of the invention relates to traffic control. More specifically various exemplary embodiments of the invention relate to parking reservation systems which assign parking spots to users based on availability. In some exemplary embodiments of the invention, users order parking spots using a user client device. According to various exemplary embodiments of the invention the user client devices are onboard computers (whether in a standard or driverless vehicle), smartphones, dedicated navigation devices (for example, a stand-alone GPS device) and/or tablet devices and/or laptop computers and/or wearable devices and/or desktop computers and/or 2G phones and/or specially equipped parking kiosks and/or and conventional phones (for example, operating through the Public Switched Telephone Network). Alternatively or additionally, in some embodiments parking docents carrying a user client device are deployed in order to assist drivers that do not have a user client device.

One aspect of some embodiments of the invention relates to user interfaces for centralized management of parking regulations. In some exemplary embodiments of the invention, the user interfaces are graphical.

Another aspect of some embodiments of the invention relates to user interfaces for analysis of usage statistics for subsets of parking spots managed by a computerized system. In some exemplary embodiments of the invention, the subsets are defined by delimiting an area on a map (for example, using a finger or stylus on a touch screen or using a mouse or trackpad on a non-touch screen).

Another aspect of some embodiments of the invention relates to load balancing among zones, where each zone contains parking spots managed by a common computerized system. In some exemplary embodiments of the invention, each zone is characterized by a maximum occupancy rate (occupancy rate=(occupied spots plus reserved spots)/total spots). According to various exemplary embodiments of the invention parking rules for a zone are changed as a maximum occupancy rate is approached.

Another aspect of some embodiments of the invention relates to maintaining a database of individual parking spots with at least three designations for each spot: Occupied, Reserved and Available. In some embodiments a fourth designation, Violation, is used to indicate a spot occupied by an unauthorized vehicle

It will be appreciated that the various aspects described above relate to solution of technical problems associated with traffic congestion resulting from cars searching for parking spots.

Alternatively or additionally, it will be appreciated that the various aspects described above relate to solution of technical problems related to inefficient use of available parking spots.

Alternatively or additionally, it will be appreciated that the various aspects described above relate to solution of technical problems related to appropriate allocation of spots for special purposes (for example deliveries).

Alternatively or additionally, it will be appreciated that the various aspects described above relate to solution of technical problems related to sign deployment and maintenance.

Alternatively or additionally, it will be appreciated that the various aspects described above relate to solution of technical problems related to changes in parking rules, for example, for special events.

In some exemplary embodiments of the invention there is provided a system including a reservation server receiving reservation input, parking confirmation input and parking exit input from at least one user client device; and a parking spot status database in communication with the server and configured to assign to each spot in the database a status selected from a group including at least available, reserved and occupied in accord with the inputs received by the server. In some embodiments the system includes a mapping engine adapted to produce map output data for each spot. Alternatively or additionally in some embodiments the system includes a reservation nesting module adapted to identify incoming reservation inputs with a defined parking duration and match them with spots that have a current status of available and a reserved status at a time that is further in the future than a present time plus the defined parking duration.

In some exemplary embodiments of the invention there is provided a system including a database of individual spots, each of the individual parking spots associated with a unique identifier (UID) and location coordinates; at least one computer workstation adapted to display a map; and a graphical user interface (GUI) operable on the workstation, the GUI adapted to receive a map area selection as a first input and at least one parking rule as a second input and apply the at least one parking rule to all of the parking spots with location coordinates in the map area. In some embodiments of the system, the workstation displays the individual on-street parking spots on the map. Alternatively or additionally in some embodiments of the system, the workstation displays a current status of each of the individual on-street parking spots on the map. Alternatively or additionally in some embodiments of the system, the second input includes a temporal limitation. Alternatively or additionally in some embodiments of the system, the second input includes a duration limitation. Alternatively or additionally in some embodiments of the system, the duration limitation is dependent on at least one additional factor. Alternatively or additionally in some embodiments of the system, the second input includes a user limitation. Alternatively or additionally in some embodiments of the system, the second input includes a vehicle type limitation. Alternatively or additionally in some embodiments of the system, the second input relates to a group of the individual on-street parking spots. Alternatively or additionally in some embodiments of the system, the second input relates to at least two members of the group consisting of a temporal limitation, a duration limitation, a user limitation, a vehicle type limitation and a limitation which relates to a group of the individual parking spots. Alternatively or additionally in some embodiments, the system includes a second input UI adapted to accept layers of rules.

In some exemplary embodiments of the invention there is provided a system including a database of individual parking spots, each of the individual parking spot associated with a unique identifier (UID) and location coordinates; at least one computer workstation adapted to display a map; and a user interface (UI) operable on the workstation, the UI adapted to receive a display of data of spots located in a geographical area as a first input and at least one parking rule as a second input and apply the at least one parking rule to all of the parking spots with location coordinates in the geographical area. In some embodiments of the system, the database includes on street and off street spots. Alternatively or additionally in some embodiments of the system, the database includes indoor spots. Alternatively or additionally in some embodiments of the system, the data display includes a table and/or a list.

In some exemplary embodiments of the invention there is provided a system including a database of individual parking spots, each of the individual parking spots associated with a unique identifier (UID) and location coordinates; at least one computer workstation adapted to display a map; a graphical user interface (GUI) operable on the workstation, the GUI adapted to receive a map area selection as a first input and at least one usage statistic as a second input; and an analytic module adapted to produce an output status report including at least one usage statistic for the parking spots with location coordinates in the map area. In some embodiments of the system, the at least one usage statistic indicates percentage of spaces currently occupied. Alternatively or additionally in some embodiments of the system, the at least one usage statistic indicates percentage of spaces currently reserved and current average reservation time. Alternatively or additionally in some embodiments of the system, the at least one usage statistic indicates percentage of spaces currently reserved for a future time and average reservation time for the future time. Alternatively or additionally in some embodiments of the system, the at least one usage statistic indicates percentage of spaces currently in violation of parking rules. Alternatively or additionally in some embodiments of the system, an output status report depicts one or more usage statistics as a function of time. Alternatively or additionally in some embodiments of the system, at least some of the individual spots are on street spots. Alternatively or additionally in some embodiments of the system, an output status report depicts one or more usage statistics based on different rules applied to the map area.

In some exemplary embodiments of the invention there is provided a system including a database of individual on-street parking spots, and individual off-street parking spots, each of the individual parking spots associated with a unique identifier (UID) and location coordinates; and an off-street spot management module in communication one or more external client devices, the off-street spot management module adapted to receive parking rules for an individual parking spot from an external client device operated by an administrator of an individual parking spot. In some embodiments the system includes a location definition module adapted to receive location coordinates defining a specific individual off-street parking spot from one of the one or more external client device, assign a UID to the location coordinates to create an individual spot definition and add the spot definition to the spot database. Alternatively or additionally in some embodiments the system includes a cue management module adapted to receive cue information related to a specific individual off-street parking spot and associate the cue information with the specific spot in a spot database. Alternatively or additionally in some embodiments of the system, the off street spot management module resides on a reservation server. Alternatively or additionally in some embodiments of the system, the off-street spot management module resides on an external client device adapted to communicate with a reservation server. Alternatively or additionally in some embodiments of the system, at least some of the individual off-street parking spots are privately owned. Alternatively or additionally in some embodiments of the system, the off-street spot management module has a user interface selected from a web based interface and a smartphone based interface.

In some exemplary embodiments of the invention there is provided a system including a database of individual parking spots, each of the individual parking spots associated with a unique identifier (UID) and location coordinates; at least one computer workstation adapted to display a map; a graphical user interface (GUI) operable on the workstation, the GUI adapted to divide the map into zones and to assign a desired occupancy rate to each zone; and a reservation server adapted to receive user parking requests including a destination from user client devices via a network, and to respond to each request by assigning an available spot closest to the destination, that does not cause any of the zones to exceed its assigned desired occupancy rate.

In some exemplary embodiments of the invention there is provided a system including: parcels of land each having a unique identifier; a database of the parcels of land; a command and control center for applying at least one use rule to said parcel of land; and a graphical user interface for displaying the at least one rule in relation to the parcels of land. In some embodiments the command and control center is configured to apply at least two different rules the parcel of land.

Unless otherwise defined, all technical terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

### GLOSSARY

For purposes of this specification and the accompanying claims the term “Region” indicates any geographical area having any or all types of parking facilities. “City” is used interchangeably with “region” unless specified otherwise.

For purposes of this specification and the accompanying claims, unless specified otherwise, the term “parking spot” or “spot” includes, for example, on-street, off-street, parking lots, garages (for example, multi-story parking towers and/or underground garages).

For purposes of this specification and the accompanying claims, unless specified otherwise, the term “venue” indicates a destination which attracts a large number of vehicles carrying occupants that share a common purpose. Examples of venues include football stadia, amusement parks, transportation hubs such as, for example, airports and train stations, and shopping malls.

For purposes of this specification and the accompanying claims, unless specified otherwise, the term “vehicle attribute” indicates either one or both technical data of the vehicle and legal status.

“Technical data” includes, but is not limited to physical dimensions (length, width and height), and engine type (powered by gasoline, hydrogen; liquid propane or electricity).

“Legal status” includes, but is not limited to, private, resident (for example, of a specific region or a specific parking zone defined within that region) emergency (for example, fire truck or ambulance), law enforcement, government (for example, municipal maintenance trucks, postal delivery vehicles), security, diplomatic, delivery, utility (for example, phone company or electric company).

For purposes of this specification and the accompanying claims the term “vehicle” indicates any wheeled conveyance used for on or off road transportation, provided that the specified vehicle is susceptible of being uniquely identified by listing in a database. This definition includes, but is not limited to, automobiles, motorcycles, bicycles, tricycles, motorbikes/scooters, buses, trucks, emergency vehicles, security vehicles, industrial vehicles and public transportation vehicles.

For purposes of this specification and the accompanying claims the terms “driver” and “user” are used interchangeably to mean a vehicle operator or vehicle passenger or other individual interacting with the system for the purpose of reserving a parking spot for a specified vehicle.

For purposes of this specification and the accompanying claims terms such as “processing,” “computing,” “calculating,” “determining,” “analyzing” or the like, refer exclusively to the action and/or processes of a computer, computing system, client/server system, or similar electronic computing device that manipulates and/or transforms data. In some embodiments these verbs are indicative of a transformation of abstract data into a concrete representation of information that has utility outside the machine on which it resides.

For purposes of this specification and the accompanying claims the terms “transmitting” and “receiving”, or their conjugates, indicate network data transfer.

For purposes of this specification and the accompanying claims “database” is represented by the acronym DB.

For purposes of this specification and the accompanying claims “Command and Control Center” is represented by the acronym CCC.

For purposes of this specification and the accompanying claims the acronym “UI” indicates user interface and the acronym “GUI” indicates graphical user interface.

For purposes of this specification and the accompanying claims the acronym “UID” indicates unique identifier.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed device, system or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The accompanying figures are:

FIG. 1 is a schematic representation of a parking system according to some embodiments of the invention;

FIG. 2a is a schematic representation of an exemplary graphic user interface for selecting a specific parking spot from a list offered by a reservation management server, displayed on a user client device;

FIG. 2b is a schematic representation of an exemplary graphic user interface for confirming arrival at specific parking spot interface assigned by a reservation management server displayed on a user client device;

FIG. 2c is a schematic representation of an exemplary graphic user interface for confirming departure from a specific parking spot assigned by a reservation management server displayed on a user client device;

FIG. 3 is a schematic representation of a system according to some exemplary embodiments of the invention;

FIG. 4 is a schematic representation of a system according to some exemplary embodiments of the invention;

FIG. 5a is a schematic representation of a system according to some exemplary embodiments of the invention;

FIG. 5b depicts an exemplary Graphical User Interface (GUI) according to some exemplary embodiments of the invention;

FIG. 5c depicts an exemplary User Interface (UI) according to some exemplary embodiments of the invention;

FIG. 6a is a schematic representation of a parking system according to some embodiments of the invention; and

FIG. 6b is a schematic representation of a parking system according to some embodiments of the invention.

### DETAILED DESCRIPTION OF EMBODIMENTS

Embodiments of the invention relate to parking systems, methods and devices.

Specifically, some embodiments of the invention are used to assign a specific vehicle to a specific parking spot. In some embodiments the assignment is for a predetermined amount of time.

Alternatively or additionally, some embodiments of the invention are used to join two or more adjacent parking subunits to create a spot for a single vehicle (for example, a standard car, oversized or requiring extra clearance for a lift).

Alternatively or additionally, some embodiments of the invention are used to manage what were previously considered as separate parking resources (e.g., on street spots and/or off-street lots or garages and/or individual privately owned-spots) as an integrated parking facility.

Alternatively or additionally, some embodiments of the invention are used to change parking rules from a central command and control center (CCC) easily and conveniently.

Alternatively or additionally, some embodiments of the invention are used to provide usage statistics to the CCC according to selected areas. According to various exemplary embodiments of the invention the statistics are presented as a function of time and/or price.

The principles and operation of systems and/or methods and/or devices according to exemplary embodiments of the invention may be better understood with reference to the drawings and accompanying descriptions.

Before describing at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of exemplification and should not be regarded as limiting.

System Overview

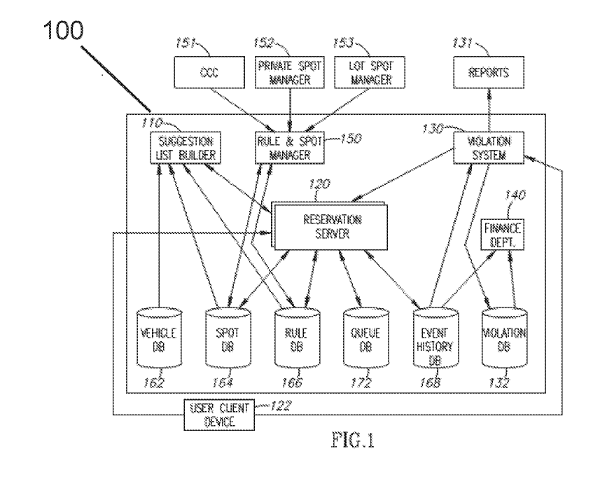

FIG. 1 is a schematic representation of a computerized parking system illustrating the context in which various embodiments operate, indicated generally as system 100. Sub-systems and related methods discussed in greater detail below may be easier to understand when considered in the context of system 100 as described here.

Referring now to FIG. 1, depicted exemplary system 100 operates a reservation server 120 which receives inputs from user client devices 122. A single user client device 122 is depicted for clarity although a much larger number will be present in actuality.

One main function of the system is to receive parking requests from user client devices 122. In one embodiment, the request entered by a user includes a vehicle registration number and an indication of a destination. Server 120 responds to each request by providing a reservation for a specific vehicle (e.g., identified by vehicle registration number) to a specific parking spot based upon a parking request from the user. In order to support this function, many embodiments of system 100 aid the operator of user client device 122 in locating and/or identifying the specific parking spot associated with their reservation.

Another main function of system 100 is to contribute to efficient enforcement of parking violations. One way that system 100 makes this contribution is by permitting user client devices 122 to report parking violations to a violation system 130.

According to various exemplary embodiments of the invention reservation server 120 communicates with one or more information resources to procure information needed to process an incoming parking reservation request from user client device 122.

Exemplary databases (DBs) in system 100 are:

Vehicle DB 162, which stores vehicle attributes (as defined in Glossary hereinabove) in association with a vehicle registration number. In some embodiments at least a portion of the information in vehicle DB 162 is available from a governmental licensing authority (for example, department of motor vehicles, department of public safety or ministry of transportation). In some embodiments system 100 communicates with an external governmental DB during processing of each incoming reservation request. In some embodiments system 100 mirrors the external governmental DB. In some embodiments, mirroring contributes to processing speed of each incoming reservation request. Alternatively or additionally, system 100 provides supplemental information to DB 162 (for example, legal attributes associated with a vehicle) and/or an icon depicting the vehicle.

Parking spot DB 164 which stores information regarding the location (i.e. location coordinates), size and current status of parking subunits. Each parking spot (which may consist of several parking subunits) is administered by the system 100. Information regarding the location, size and current status of parking spots is also be stored in spot DB 164.

In some embodiments system 100 automatically (e.g., based on a predetermined system law) changes rules based on current status of parking subunits and/or analytics. Alternatively or additionally, in some embodiments information from DB 164 is used, for example, by rule and spot manager 150 to automatically and dynamically change rules in rule DB 166. For example, if the current status of a spot or spots and/or analytics of a spot or spots fulfils a predetermined system law then a rule change may be applied automatically.

In other embodiments rules are changed manually.

In some exemplary embodiments of the invention, each parking subunit and/or specific spot has a unique identifier (UID). In some embodiments the UID is visible to a user of the system when they park their car (for example, painted on the pavement or on a wall or a sign adjacent to the subunit(s) or spot). In some embodiments spot DB 164 also stores status for future time points (for example. if advance reservations are accepted and/or if the current use is subject to a time limitation). Typically spot DB 164 assigns a status of “available” or “not available” for each individual parking subunit as a function of time. The status “available” for a subunit indicates that it is not occupied and not reserved and not precluded from use by any rule. The status “not available” indicates that the spot is either occupied or reserved or precluded from use by a rule or “uncertain”. In some cases a temporary “uncertain” status is applied to spots and/or parking subunits which are the subject of complaints or reports. The “uncertain” status will only be maintained until the actual status is investigated (e.g., by dispatching system personnel to inspect the parking spot). In some embodiments sub statuses are applied, such as “reserved”, “occupied”, “in violation”.

Rule DB 166, which stores parking rules for each individual spot administered by the system. According to various exemplary embodiments of the invention, rule changes are applied to individual spots and/or groups of spots by one or more parties. As a result, multiple rules may apply to a given spot at any given moment. Alternatively or additionally, rules often have multiple attributes as described hereinbelow in the section entitled “Exemplary rule attributes”.

Queue DB 172, which stores incoming parking reservation requests that have not yet been transformed into reservations for a specific spot and/or reservations for a specific spot which have not yet been taken up by an assigned car parking in the assigned spot.

Event history DB 168, which stores “parking events” for a particular spot defined in terms of at least a vehicle registration number and a parking duration. In many embodiments details such as, for example, date, reservation time, time in, time out, specific parking spot and hourly rate are also stored. Periodically, events from event history DB 168 are sent from system 100 to finance department 140 for payment processing.

Violation history DB 132, which stores “violation events” defined in terms of at least a vehicle registration number and a specific spot. In many embodiments details such as, for example, date, time, infraction type (e.g., parked for 3 hours in a 2 hour spot or parked in a spot reserved for another vehicle) are stored. In some embodiments, evidence (e.g., a photograph of the infraction with a date/time stamp) is also stored in DB 132. Periodically, events from DB 132 are sent from system 100 to finance department 140 for payment processing.

In the depicted embodiment, reservation server 120 also communicates with suggestion list builder 110 to process at least some of the incoming parking reservation requests from user clients 122. Suggestion list builder 110, in turn, communicates with DBs 162, 164 and 166 to assemble a list of available spots in proximity to a destination defined in the request received from user client device 122 and suitable for the car defined by the vehicle registration number in the request.

Alternatively or additionally, in some embodiments reservation server 120 also communicates with violation system 130 and relays violation information to spot DB 164. According to various exemplary embodiments of the invention violation information includes discovery of an unauthorized vehicle in a specific spot and/or a report of removal by a law enforcement agency of an unauthorized vehicle from a specific spot. Both the discovery and the removal report result in a status change for the specific spot in question in DB 164. In some embodiments violation system 130 reports events which prevent the use of or access to a parking spot. Examples of such events include for example, a fallen tree or piles of snow resulting from plowing.

In some embodiments violation system 130 also issue reports 131 in the form of parking tickets.

In the depicted embodiment, system 100 includes a rule and spot manager 150 functioning to relay externally provided rules to spot DB 164. In the depicted embodiment externally supplied rules originate from a command and control center (CCC) 151 and/or from lot spot manager 153 and/or from private spot manager 152. Each of CCC 151, private spot manager 152 and lot spot manager 153 operate a rule input interface adapted to their specific needs. The rule input interface for CCC 151 is typically the most robust of the three. The rule input interface for CCC 151 handles the largest number of spots and deals with the largest number of possibilities. The rule input interface for lot spot manager 153 is typically intermediate in capacity. For example, the rule input interface for lot spot manager 153 may deal primarily with rules applicable to a whole parking facility, or a whole floor within a parking facility. The rule input interface for private spot manager 152 typically has the least capacity. Private spot manager 152 deals with rules for a single spot.

Exemplary Single Parking Reservation Request

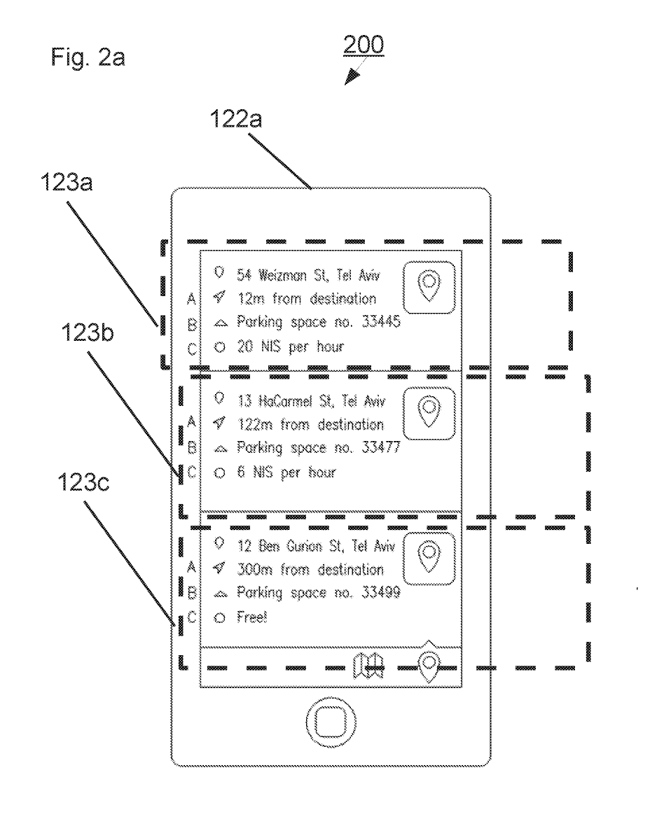

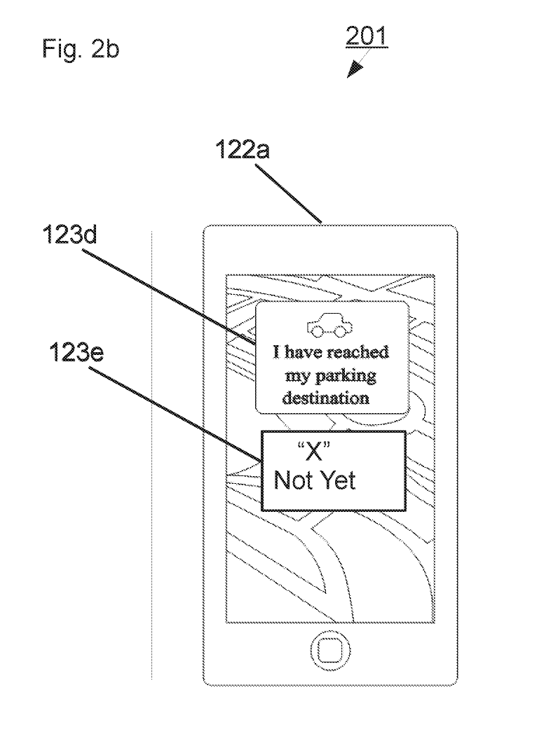

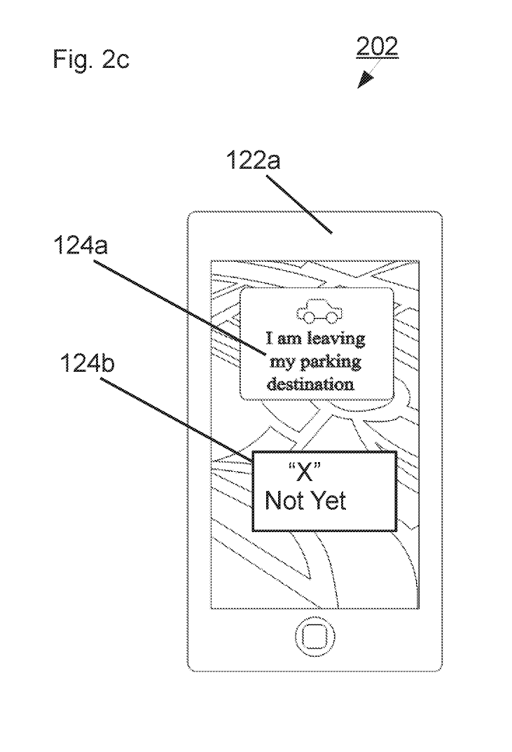

As an example of how system 100 works, the processing of a single reservation request, which defined 52 Weizmann St. in Tel Aviv as a destination, is described with respect to both the functionalities of system 100 (FIG. 1) and of a specific user client device 122a (FIGS. 2a-2c) in the form of a smart phone running a software application (“app” or “parking app”) that serves as a communication interface between system 100 and the display of device 122a. According to various exemplary embodiments of the invention, the vehicle registration number is either included in the request or is available to the system from a user profile established previously (For example, during installation of the app).

Reservation server 120 of system 100 (FIG. 1) receives the request and relays it to suggestion list builder 110. List builder 110 analyzes information in DBs 162, 164 and 166 and assembles a list of available parking spots that are relevant to the specific request. According to various exemplary embodiments of the invention relevance is analyzed either according to a user profile and/or according to rules programmed into list builder 110. The list of available parking spots is relayed to user client device 122a via reservation server 120.

FIG. 2a is a schematic representation, indicated generally as 200, of an exemplary user client device 122a displaying a user interface for selecting a specific parking spot from a list offered by reservation management server 120 after construction by list builder 110. In the depicted embodiment each of list items 123a, 123b and 123c includes a street address, a distance from the requested destination and an hourly rate. An operator of device 122a makes a selection by touching one of the items in the list or by issuing a voice command.

In some embodiments selection of a list item issues an instruction to a navigation app running on user client device 122a and the navigation app guides the operator of 122a to a specific parking spot using location coordinates associated with the item selected from the list (but typically not displayed on the screen).

FIG. 2b is a schematic representation, indicated generally as 201, of user client device 122a displaying an exemplary interface for confirming arrival at a specific parking spot assigned by reservation management server 120 (FIG. 1) overlaid on the map of the navigation app. Since the navigation app is aware of current location and speed (for example, from a tracking component installed in device 122a), in some embodiments the navigation app displays a prompt 123d to confirm parking as the vehicle approaches the spot and/or slows down in proximity to the spot. The user confirms as described above for selection of a list item. In the depicted embodiment, a “do not confirm” icon 123e is also provided. Upon receipt of confirmation of parking at server 120, the server updates the sub-status of the specific spot and/or of the parking subunits comprising the spot in DB 164 from “reserved” to “occupied”.

FIG. 2c is a schematic representation, indicated generally as 202, of user client device 122a displaying an exemplary interface for confirming departure from a specific parking spot assigned by a reservation management server 120. Since the navigation app is aware of current location and speed (for example, from a tracking component installed in the device), the navigation app displays a prompt 124a to confirm exit from the parking spot as the vehicle departs from the spot and/or attains a velocity that indicates the operator of the device is not on foot (for example, 25 km/hr). The user of the device confirms as described above for selection of a list item. In the depicted embodiment a “do not confirm” icon 124b is also provided. Upon receipt of confirmation of exit from the parking spot at server 120, the server 120 updates the sub-status of the specific spot and/or the parking subunits comprising the spot) in DB 164 from “occupied” to “unoccupied” or “reserved” as appropriate.

This simplified example does not demonstrate the full range of capabilities of system 100.

First Exemplary System

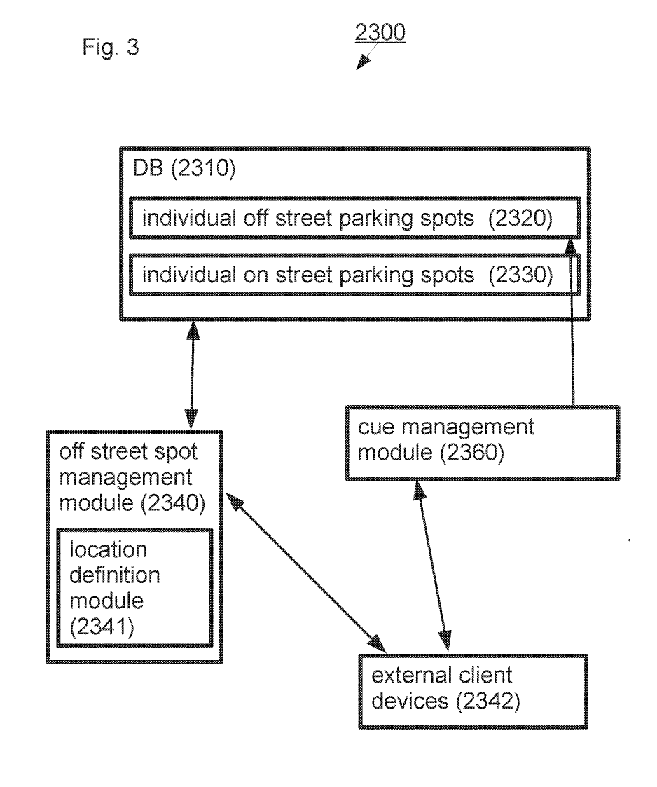

FIG. 3 is a schematic representation of a computerized parking management system, indicated generally as 2300, according to some embodiments of the invention. Depicted exemplary system 2300 includes a database 2310 of individual on-street parking spots 2330 and individual off-street parking spots 2320, each of the individual parking spots associated with a unique identifier (UID) and location coordinates. The depicted system also includes an off-street spot management module 2340 in communication one or more external client devices 2342 and adapted to receive parking rules from an external client device 2342 operated by an owner of each of the individual off-street parking spots. The term “external client” indicates spot management function but the client devices can be any of the device types listed in the section entitled “Exemplary user client devices”.

In some embodiments system 2300 includes a location definition module 2341 (depicted here as part of spot management module 2340) adapted to receive location coordinates defining a specific individual off-street parking spot from one external client devices 2342 and assign a UID to the location coordinates to create an individual spot definition and add the spot definition to spot database 2310. For example, in some embodiments an owner of an individual off-street spot uses a location function of a smartphone to acquire and transmit location coordinates of a specific parking spot to module 2341.

In the depicted embodiment, system 2300 includes a cue management module 2360 adapted to receive cue information from the external client device 2342. The cue information is used in guiding a vehicle to a specific individual off-street parking spot. The cue information transmitted from client device 2342 to module 2360 is stored in DB 2310 in association with a specific off-street spot 2320 in the DB 2310. According to various exemplary embodiments of the invention cue information includes audio and/or text and/or images. Although modules 2341 and 2360 are depicted separately for clarity, the functions of both are incorporated into a single module in some embodiments.

In some embodiments off-street spot management module 2340 resides on reservation server 120 (FIG. 1). According to these embodiments, owners of off-street spots log in and have access privileges only for spots they own.

In some embodiments off-street spot management module 2340 resides on an external client device 2342 adapted to communicate with reservation server 120. According to these embodiments, spot owners manage their spots on the external client (using any device 2342) and submit rules to reservation server 120. Parking lot owners can manage their spots on an individual basis (for example a single spot subscription sold by lot equals a “reservation blackout” for the system), in groups (for example lease of a whole floor of a parking garage to a company) or on a whole lot basis (for example a global rate change).

In some embodiments at least some of individual off-street parking spots 2320 are privately owned.

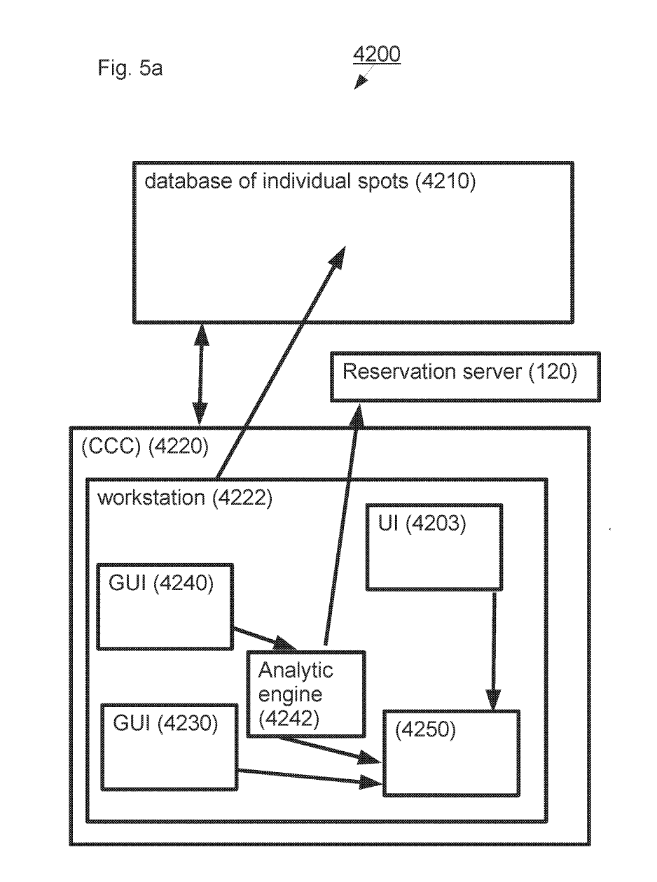

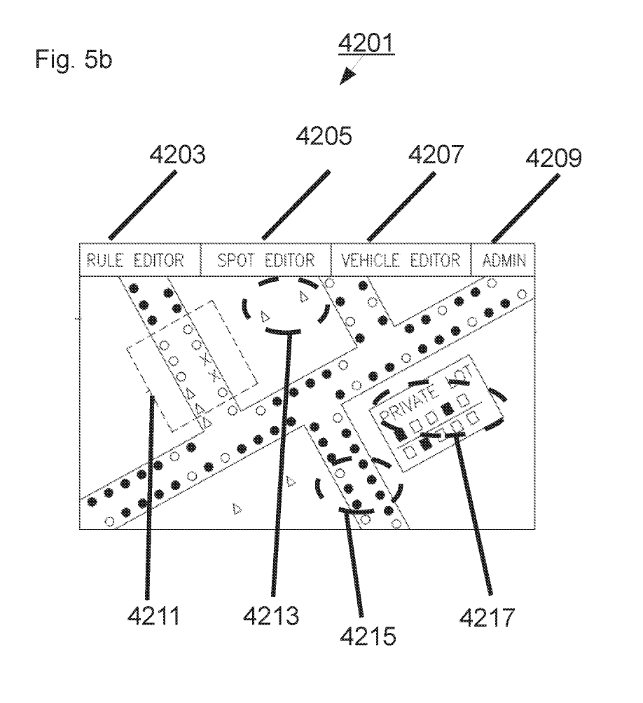

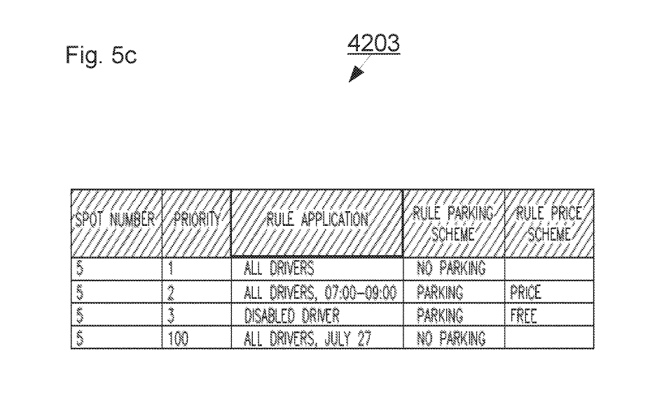

In some embodiments the private spot management module 152 has a user interface selected from a web based interface and a smartphone based interface. In some embodiments the interface is similar to that depicted in FIG. 5C except that the leftmost column is either absent or always populated with the single spot belonging to the user.

Exemplary Three Status System

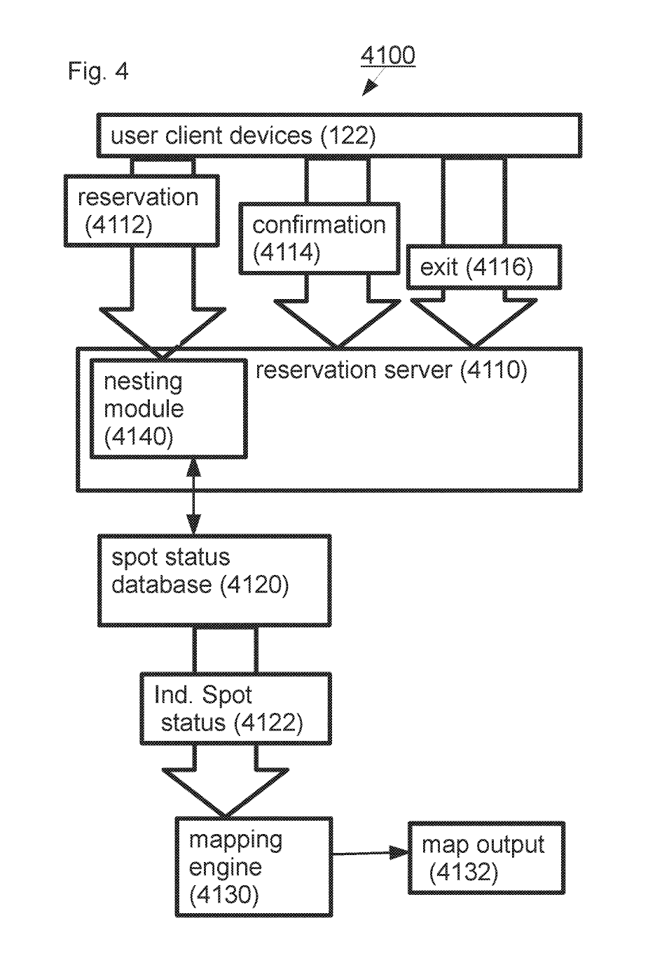

FIG. 4 is a schematic representation of a centrally managed parking system, indicated generally as 4100, according to some exemplary embodiments of the invention. Depicted exemplary system 4100 receives inputs from user client devices 122. A single device 122 is depicted for clarity, although in actuality a large number are typically present.

A single user client device 122 interacts with the system by providing, in sequence, a reservation 4112, a parking confirmation 4114 and an exit notification 4116. These three inputs together define a parking event.

Depicted exemplary system 4100 includes a reservation server 4110 receiving parking event inputs (as described above) from user client devices 122 and a parking spot status database 4120 in communication with server 4110 and configured to assign to each individual spot in the database a status 4122 selected from at least three possibilities selected from the group consisting of available, reserved and occupied in accord with the parking event inputs received by server 4110. In some embodiments, when a parking spot is occupied by something other than the vehicle for which the spot was reserved, a “violation” status is assigned to the spot. Thus, in some embodiments, “not available” is a conglomeration of reserved, occupied, prohibited and violation; and “available” normally indicates an absence of any other designation, although there may be a situation in which a spot is currently available, even though it may have a future reservation.

In the depicted embodiment system 4100 includes a mapping engine 4130 adapted to produce map output data for each spot. In the Figure, a map 4132 with each displayed spot and its status are visible to a user of the workstation.

The depicted exemplary embodiment also includes a reservation nesting module 4140 adapted to identify incoming reservation inputs 4112 with a defined parking duration and match them with spots that have a current status of available and a reserved status at a time that is further in the future than a present time plus the defined parking duration for a vehicle currently occupying the spot.

Exemplary Double Parking Embodiment

In some exemplary embodiments of the invention, system 100 (FIG. 1) creates temporary spaces which blocks the egress of a vehicle parked in a permanent space. The temporary spaces are assigned a temporary UID and location coordinates in spot DB 164 and are handle as other spots, with the caveat that a reservation filled with a temporary spot must be for a time that ends before the vehicle parked in the permanent space is scheduled to leave. In some embodiments there is a provision for depositing keys with an attendant to facilitate early departures from permanent spots and/or late departures from temporary spots. In some embodiments double parking creates additional parking spots on a demand responsive basis.

Exemplary Reservation Snatching Embodiment

In some embodiments system 100 permits a vehicle to park in an empty spot which is reserved for another vehicle. According to these embodiments, a user client device 122 is used to report what spot has been taken (for example using the UID and/or pavement markings and/or location coordinates). The system responds by transferring the “snatched” reservation to another spot.

Exemplary GUI for Rule Management

FIG. 5a is a schematic representation of a centrally managed parking system, indicated generally as 4200, according to some exemplary embodiments of the invention.

Depicted exemplary system 4200 includes a database 4210 of individual parking spots. Each of the individual spots is associated with a unique identifier (UID) and map coordinates.

Depicted exemplary system 4200 also includes a command control center (CCC) 4220 with at least one computer workstation 4222 adapted to display a map and a graphical user interface (GUI) 4230 operable on the workstation.

FIG. 5b is a schematic representation of an exemplary GUI 4230 of FIG. 5a indicated generally as GUI 4201. Depicted exemplary GUI 4201 is adapted to receive a map area selection 4211 as a first input and at least one parking rule as a second input.

A map area may include one or more parking spots. A map area may include contiguous spots or separated spots. In the present example, the selection of a map area 4211 may be performed by a user input device such as a mouse. Specifically one point or a set of points may be selected by positioning the mouse cursor thereover and pressing the mouse button, thereby to define the edges of the area 4211. The set of points defining the edges of the area is used to define an array of points within the area using well known algorithms which check whether a point is inside a polygon.

In the depicted embodiment the above-mentioned second input is made by selecting rule editor 4203 which opens a rule editing interface. An exemplary rule editing interface is depicted in FIG. 5c as table 4203 (a spreadsheet for data entry) which serves as a user interface for data entry. This is described in detail in section entitled “Exemplary rule attributes” and “Exemplary rule application schemes” hereinbelow.

Operation of the rule editing interface in conjunction with map area selection 4211 populates the leftmost column of table 4203 with all spots in map area selection 4211. Rules entered in other columns of the table 4203 are then applied to all spots with location coordinates within the selected map area.

In depicted embodiment 4201 the map displayed on workstation 4222 displays individual on-street parking spots on the map (for example 4215). In depicted embodiment 4201 the map displayed on workstation 4222 also displays individual off-street parking spots on the map (for example 4213) and spots in off-street parking lots or garages map (for example 4217). Alternatively or additionally, in depicted embodiment 4201 the map displayed on workstation 4222 displays a current status of each of individual on-street parking spots on the map. In the depicted embodiment current status of available is indicated by an empty circle, current status of reserved is indicated by a triangle and current status of occupied is indicated by a filled circle. Each “X” indicates a spot where parking is currently prohibited.

In depicted embodiment 4201, spot editor 4205 provides an interface for entering dimensions (length, width, and height clearance of spots) and/or for entering other spot features (for example, indoor, electric charger, rear clearance or side clearance). Information entered via spot editor 4205 is stored in spot DB 164 (FIG. 1) and/or 4210.

In depicted embodiment 4201, vehicle editor 4207 provides an interface for entering status definitions (for example resident of a particular zone or handicap) to vehicles based on vehicle registration number. Information entered via vehicle editor 4207 is stored in vehicle DB 162 (FIG. 1).

In depicted embodiment 4201, “Admin” interface 4209 is used to set permissions of access by private spot manager 152 and/or lot spot manager 153 (FIG. 1).

In some embodiments the above-mentioned second input includes a temporal limitation. According to various exemplary embodiments of the invention temporal limitations indicate specific hours and/or specific days of week and/or specific types of days (for example holidays).

Alternatively or additionally, in some embodiments the second input includes a duration limitation. Exemplary duration limitations include, but are not limited to, 30 minutes, one hour two hour and three hour parking and unlimited from eleven pm to six am. In some embodiments system 100 adjusts the duration limitation in response to events. For example, if occupancy percentage of spots in a predefined zone increases, the system responds by decreasing the permitted parking duration from 30 minutes to 20 minutes.

Alternatively or additionally, in some embodiments the second input includes a price limitation. According to various exemplary embodiments of the invention the price is expressed as an hourly rate or a fixed price per parking event. In some embodiments, raising and lowering prices contributes to a change in percentage of occupied spaces in a zone.

Alternatively or additionally, in some embodiments the second input includes a user limitation. For example, in some embodiments a car with handicapped status has greater access and/or exempt from payment. For example, in some embodiments car registered to an address on a certain street gets payment exemption on that street.

Alternatively or additionally, in some embodiments the second input a vehicle type limitation. For example, no truck parking during rush hour and/or trucks exempt from payment before 7 AM or after 7 PM.

Alternatively or additionally, in some embodiments the second input relates to a group of individual on-street parking spots. For example, on a residential street with 50 on-street spots, 40 are reserved for residents of the street during specified times and all 50 are reserved for residents at other times.) For example, in a parking lot with 2000 spots there will always be 5 available spots available for handicap vehicles. In some embodiments as the conventional 5 blue painted spots near the door fill up and/or are reserved, the system reserves additional spaces in the lot for handicap vehicles. According to this embodiment, it is possible to create a parking area which always has “5 more” handicap spaces available.

Alternatively or additionally, in some embodiments the second input relates to at least two, at least three or at least four members of the group consisting of a temporal limitation, a duration limitation, a price limitation, a user limitation, a vehicle type limitation and a limitation which relates to a group of the individual on-street parking spots.

FIG. 5b (4203) and FIG. 5c 4203 depict a second input UI adapted to accept layers of rules.

Exemplary UI for Rule Management

Referring again to FIG. 5a, some embodiments of system 4200 include a database of individual parking spots 4210, each of the individual parking spots associated with a unique identifier (UID) and location coordinates and a command control center (CCC) 4220 with at least one computerized workstation 4222 adapted to display a map.

In some embodiments system 4200 includes a user interface (UI) 4203 operable on workstation 4222. UI 4203 is adapted to receive display of data of spots located in a geographical area as a first input and at least one parking rule as a second input and apply the at least one parking rule to all parking spots with location coordinates in the geographical area. In some embodiments database 4210 includes individual on street and individual off-street spots. Alternatively or additionally, database 4210 includes indoor spots.

Alternatively or additionally, in some embodiments the data display of the first input includes a table and/or a list. For example, a highlighted portion of a spreadsheet serves as the data display of the first input.

Exemplary GUI for Analytics

Referring again to FIG. 5a, some embodiments of system 4200 include a database of individual parking spots 4210, each of the individual parking spots associated with a unique identifier (UID) and location coordinates and a command control center (CCC) 4220 with at least one computerized workstation 4222 adapted to display a map.

In some embodiments system 4200 includes a graphical user interface (GUI) 4240 operable on workstation 4222. GUI 4240 is adapted to receive a map area selection as a first input and at least one usage statistic as a second input. In some embodiments usage statistics are input via Admin. interface 4209 (FIG. 5b).

In some embodiments system 4200 includes an analytic engine 4242 adapted to produce an output 4250 status report including at least one usage statistic for the parking spots with location coordinates in map area. According to various exemplary embodiments of the invention the usage statistics for the spots in the output are for individual spots or for all spots defined by the first input as a group.

In some embodiments, the at least one usage statistic indicates percentage of spaces currently occupied.

Alternatively or additionally, in some embodiments the at least one usage statistic indicates percentage of spaces currently reserved and current average reservation time. As used here “reservation time” indicates an elapsed time from when an order was placed until parking was confirmed.

Alternatively or additionally, in some embodiments the at least one usage statistic indicates percentage of spaces currently reserved for a future time and average reservation time for the future time.

Alternatively or additionally, in some embodiments the at least one usage statistic indicates percentage of spaces currently in violation of applicable parking regulations.

Alternatively or additionally, in some embodiments the output 4250 status report depicts one or more usage statistics as a function of time.

Alternatively or additionally, in some embodiments at least some of the individual spots are on street spots.

Alternatively or additionally, in some embodiments the output status report depicts (in output 4250) one or more usage statistics relative to different rules applied to the map area.

Additional Exemplary System

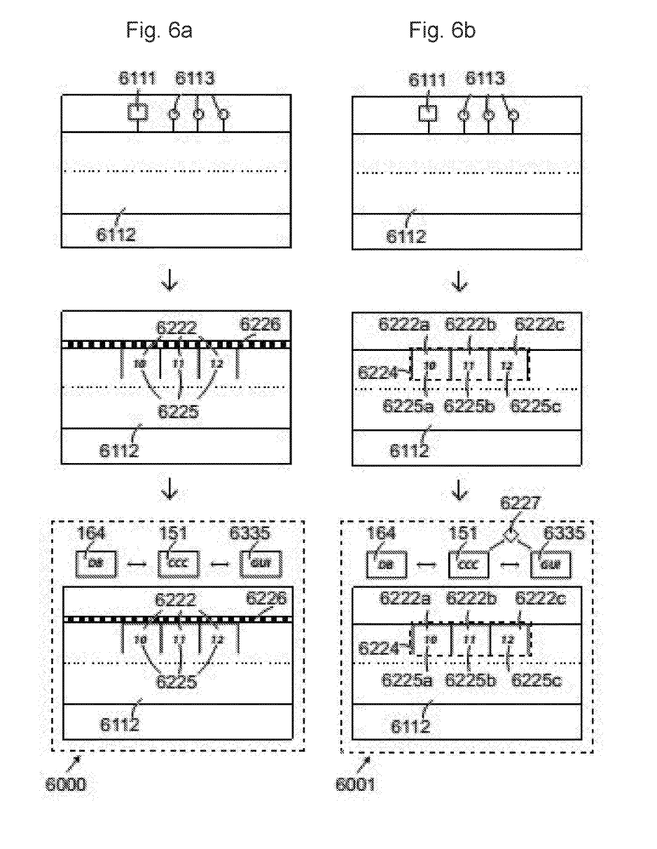

FIG. 6A schematically illustrates that current parking solutions for parking on street 6112 include the use of equipment such as signs 6111 depicting use rule (e.g., parking rules) for the street 6112 and parking meters 6113. In some embodiments of the invention currently used equipment is eliminated. Alternatively or additionally, in some embodiments a street such as street 6112 is divided into parcels of land such as subunits 6222, each parcel of land having a unique identifier 6225.

Depicted exemplary system 6000 includes a database (DB) such as spot DB 164 (FIG. 1) of parcels of land or subunits 6222. In some embodiments spot DB 164 includes at least the unique identifiers 6225. Alternatively or additionally, in some embodiments system 6000 includes a command and control center (CCC) 151 which applies at least one use rule to a subunit 6222 or to several subunits. For example, in some embodiments CCC 151 applies a payment parking rule to some or all of the subunits, or CCC 151 applies a handicap vehicle only rule to some of the subunits. According to various exemplary embodiments of the invention CCC 151 applies any other rule and/or rule type to one or more subunits 6222.

Alternatively or additionally, in some embodiments system 6000 includes a user interface. In some embodiments the UI is a GUI, for example GUI 6335. Depicted exemplary GUI 6335 displays a rule in relation to the parcel of land. In some embodiments GUI 6335 is available to a CCC 151 computer workstation. According to these embodiments, a user of the workstation sees the rules applied to each subunit. Current and/or past and/or future rules are displayed per subunit. In some embodiments GUI 6335 is available on a warden's user client device, in some embodiments the warden's user client device is in communication with the CCC 151. According to these embodiments, a warden sees the rules applied to any specific subunit. In yet another embodiment GUI 6335 is available on a user client device 122 (e.g., a driver's device or a kiosk 900 running an application according to exemplary embodiments of the invention).

Alternatively or additionally, in some embodiments street 6112 is marked, e.g., by marking 6226, to advise drivers that the parcels of land 6222 are managed by CCC 151. In some embodiments other markings that are not necessarily on the street are used.

For example, CCC 151 communicates with spot DB 164 via rule and spot manager 150 to apply a rule on a subunit 6222. In some embodiments the rule is displayed on GUI 6335 at the CCC 151 or on GUIs of user client devices 122. According to various exemplary embodiments of the invention one or more rules to a subunit causes different subunits to be available for parking to different vehicles. For example, in some embodiments a driver using a method according to an embodiment of the invention is directed to a parking space (which may include one or more subunits) efficiently with no need for signs, meters or other equipment.

In one embodiment, which is schematically illustrated in FIG. 6B system 6001 includes a processor 6227 for calculating a parking spot using the parcels of land. Alternatively or additionally, in some embodiments processor 6227 communicates with DB 164 and/or CCC 151 and/or with GUI 6335 (for example a GUI on user end device 122a of FIG. 1). Alternatively or additionally, in some embodiments processor 6227 calculates a parking spot 6224 using subunits 6222a, 6222b and 6222c as basic units.

In some exemplary embodiments of the invention, subunits 6222a, 6222b and 6222c are of equal size and a parking spot 6224 includes one or more contiguous subunits. In other embodiments subunits 6222a, 6222b and 6222c are differently shaped and/or sized. Thus, in one example, a single parking spot 6224 includes several contiguous subunits and is associated with several unique identifiers (e.g., by all unique identifiers 6225a, 6225b and 6225c making up the parking spot 6224 or by the unique identifiers 6225a and 6225c marking the boarders of the parking spot 6224).

In some embodiments calculating a parking spot 6224 is done by using suitable algorithms as described herein. For example, calculating a parking spot 6224 is based at least on vehicle size. In one example, a parking spot calculated for a large vehicle (e.g., a truck) includes three contiguous parcels of land (e.g., 6222a, 6222b and 6222c) whereas a parking spot calculated for a small vehicle (e.g., motorcycle) includes only one parcel of land. Thus, when a request for parking of a large vehicle is accepted at reservation server 120 a different parking spot is calculated and displayed on GUI 6335 than when a request for parking a small vehicle is accepted at reservation server 120. For example, a GUI 6335 displaying a parking spot for a truck shows a parking spot identified as 6225a-6225c whereas a GUI 6335 displaying a parking spot for a motorcycle shows a parking spot identified as 6225a.

Exemplary User Client Devices

According to various exemplary embodiments of the invention a smartphone (e.g. using APPLE IOS or ANDROID OS), a tablet device, a wearable device (e.g. APPLE watch or ANDROID wear), a personal computer (e.g. laptop or desktop), an onboard computer in a vehicle, a 2G mobile phone, a conventional phone (operating through the public switched telephone network) and a kiosk serve as a user client device. According to various exemplary embodiments of the invention the onboard computer in a vehicle is selected from the group consisting of a portable device, a built in device in a standard (driver operated) car and a built in computer on an automatic (driverless car).

Different user client device types interface with the system in different ways.

For example, a smartphone or onboard computer interfaces with the system using software installed on the client device. Depending on the software design the system transmits information (for example, cues and/or options) to the client device for display on the screen of the client device and/or as audio output though a speaker of the client device. A user input responses to the device using a touchscreen and/or by voice activation. In some embodiments if no user input is received within a pre-set time period, the system proceeds according to a default selection (for example, the first item in a list).

Alternatively or additionally, in some embodiments a smartphone or 2G phone transmits an SMS to a designated telephone number which serves as a system interface. Successive exchanges of information are conducted via SMS according to these embodiments.

Alternatively or additionally, in some embodiments a tablet device or a personal computer (for example, laptop or desktop) serves as a user client device. According to these embodiments exchanges between the user client and the system of information are, for example, via an internet portal operated by the system.

Alternatively or additionally, in some embodiments a smartphone or 2G phone or a conventional telephone places a telephone call to a designated telephone number which serves as a system interface. According to these embodiments exchanges of information are via an IVR (integrated voice response) system and/or a call center.

In some embodiments a dedicated kiosk serves as a user client device for users of the system that do not have another device available to them and/or to supplement another user client device employed to complete a portion of the reservation process. For example, a user that used their home telephone to reserve a parking spot via an IVR interface uses a kiosk in proximity to their assigned spot to notify the system when they arrive and depart from their assigned parking spot.

In some embodiments a parking attendant operates a user client device for users that do not have a device of their own. Alternatively or additionally, in some embodiments the system identifies a vehicle based upon a user client device. For example, in some embodiments a phone number is associated with vehicle registration number in a user profile (e.g. stored in vehicle DB 162). In those embodiments where a smartphone serves as a user client device, the phone number of the user client is available even if an incoming reservation request is via data network, as opposed to in the form of a telephone call.

Vehicle Icons

In some embodiments, system 100 (FIG. 1) includes, or has access to, a database of vehicle icons. Icons are designed to convey information pertaining to general vehicle type and/or appearance (for example, car/truck/SUV) and/or specific vehicle type (for example, sedan/station wagon/coupe/hatchback) and/or manufacturer (for example, FORD, CHEVY, HONDA, MAZDA, TOYOTA) and/or model (for example, COROLLA, CAMRY) and/or model year (or sets of model years with distinctive design features) and/or other characterizing features, such as color or shape. According to various exemplary embodiments of the invention the icons are two dimensional or three dimensional. In some embodiments the icons are empty line drawings and are filled with an appropriate color prior to use. In other exemplary embodiments of the invention, each icon is stored as multiple copies in different colors. In some embodiments icons are stored in vehicle DB 162 as a portion of individual vehicle records or as a separate collection of information within the DB.

Generation of Location Mockups

In some embodiments, system 100 (FIG. 1) uses a UID and/or position coordinates of a specific parking spot to generate a visual representation of the spatial context of the parking spot. The visual representation, in digital format, is transmitted to a user client device 122. In some embodiments user client device 122 is destined to the specific spot (for example, a smartphone or onboard computer). In some embodiments the transmission of the visual representation is made as the relevant user client device approaches the spot. In some embodiments a single fixed angle picture serves as the visual representation. In other exemplary embodiments of the invention, the visual representation is a virtual reality file which changes as the user client device moves relative to the assigned parking spot.

In some embodiments building faces from external sources (for example, GOOGLE MAP™ street view) are added to the visual representation.

Exemplary View Switching

In some embodiments the view on a user client device switches to perspective or street view as the device approaches the destination and/or an assigned parking spot. According to various exemplary embodiments of the invention the switch occurs when a proximity threshold is crossed. According to various exemplary embodiments of the invention the proximity threshold is defined in terms of distance and/or estimated arrival time. Alternatively or additionally, in some embodiments reduction of vehicle speed below a speed threshold triggers a switch to perspective view/street view. In some embodiments this view switching indicates presentation of one or more additional views (for example, using a split screen or pop-up window). In some embodiments a single fixed angle picture is presented as the “switched view” (for example, in a pop-up window).

Exemplary Rule Attributes

According to various exemplary embodiments of the invention access to parking spots through the reservation system is controlled by rules. Each rule includes one or more rule attributes. In some embodiments a single rule includes 2, 3, 4, or 5 or more attributers. Alternatively or additionally, in some embodiments multiple rules are applied to a given parking spot. Exemplary rule attributes include, but are not limited to spot ownership type, temporal limitations (for example, days and/or hours during which the rule applies); user type limitations (for example, residents only), duration limitations (for example, maximum stay of 0.5, 1, 2 or 3 hours), and legal status. In some embodiments rules include an hourly payment rate for the spot. In FIG. 5c the “rule scheme” may be a price rule scheme as exemplified in the table 4203, a duration rule scheme, etc. other relevant attributes schemes. In some cases the rule scheme includes a function of the attribute (e.g., price function or duration function) such that changes to the attribute may be dynamic and dependent on a changing status and/or on predetermined laws.

In some embodiments rules have start date and/or end dates and/or times as attributes. According to these embodiments future reservations for spots are handled in accord with the rules which will be applicable on the relevant date/time and not in accord with the rules in effect at the time the reservation is received.

Exemplary Rule Application Schemes

In some embodiments rules are applied in layers, with a highest layer number governing. FIG. 6 is a table, indicated generally as 1600 illustrating an exemplary rule application scheme according to some embodiments of the invention.

In the depicted embodiment a single spot number (5) is depicted in the leftmost column for clarity although the system is capable of applying rules, or changes to rule, to large numbers of spots concurrently.

In the depicted embodiment second column from the left indicates priority or layer. According to this embodiment the highest priority, or top layer, governs lower priorities or layers for spot(s) indicated in the leftmost column.

The middle column indicates rule attributes. Again the rules presented here are simplified for clarity although a single rule can be defined in a large number of attributes as explained in “Exemplary rule attributes: hereinabove”.

The second column from the right indicates parking scheme in terms of parking/no parking for vehicles and potential parking events matching all the attributes of the rule in the highest priority applicable layer.

The rightmost parking indicates price scheme in terms of free or fixed price for vehicles and potential parking events matching all the attributes of the rule in highest priority applicable layer.

Alternatively or additionally, in some embodiments the base layer excludes all vehicles at all times. According to these embodiments, each successive layer adds permissions. In some embodiments permissions are described in terms of rule attributes as detailed hereinabove and/or in terms of additional attributes and/or in terms of combinations of 2, 3, 4 or 5 or more attributes.

Elevation Considerations

In order to facilitate navigation to a specific spot in a multistory garage, elevation coordinates are used in some embodiments. Alternatively or additionally, in some embodiments a UI displays level row and spot number on the display when the vehicle approaches the garage. Use of such a UI is advantageous in situations where tracking devices used in many smartphones do not function well, such as underground facilities.

Parking Lots/Garages

In terms of rulemaking considerations, some lots/garages may be permitted to rent out spots, or blocks of spots, independently of the system. For example, garages accustomed to leasing blocks of spots to companies in an adjacent office building are unlikely to surrender this revenue stream in order to participate in the system. In such cases the garage operator uses lot spot manager 153 to enter rules in rule and spot manager 150 indicating that the leased spots are either unavailable to any car at any time or are reserved for a specific vehicle identification number for the entire term of the lease. According to various exemplary embodiments of the invention rule making for spots within a parking lot or garage remains in the hands of owners (for example, for price determination) and/or be relegated to city control (for example, for traffic control purposes or load balancing). In some embodiments different levels of priority for spaces in a lot/garage are given to owner and city.

Exemplary Advantages

Systems and methods described hereinabove contributes to a reduction in maintenance of physical infrastructure (for example, parking meters and/or parking regulation signs and/or access gate), as a driver may be directed to a parking spot based on a GUI as exemplified in FIG. 7b.

Alternatively or additionally, systems and methods described hereinabove contribute to a reduction in supervision requirements (personnel and/or vehicles), for example, by use of violation system 130 in FIG. 1.

Alternatively or additionally, systems and methods described hereinabove contribute to a reduction in over-payments and under-payments relative to parking meters, for example, by using history DB 168 in FIG. 1.

Alternatively or additionally, systems and methods described hereinabove contribute to increased utilization of both public and private parking resources and/or to increased flexibility in managing parking resources as a whole and/or individual parking spots by use of a method for customizing parking spots to size of vehicle as exemplified in FIG. 4.

Alternatively or additionally, systems and methods described hereinabove enable advance reservation of a specific spot even in on-street parking situations.

Alternatively or additionally, systems and methods described hereinabove do not require sensors installed in spots, although they are amenable to use in the context of sensor based systems.

Exemplary Network Communications

According to various exemplary embodiments of the invention data is transmitted across a network. According to various exemplary embodiments of the invention the networks include the Internet and/or local area networks (for example, at a command and control center) and/or cellular communications networks (voice and/or data) and/or the public switched telephone network (PSTN).

First Exemplary Use Scenario

In many cases the regional authority is aware of the date of a special event which will disrupt traffic, weeks or even months ahead of the event. More specific details of the event and of the specific areas to be affected may not be known until much closer to the event.

Referring again to FIG. 1, CCC 151 prevents all parking reservations of the date of the event in the affected region well in advance. This “blackout” status is imposed by implementing a rule in rule and spot manager 150 with “all drivers” and the date of the event” as attributes, “no parking” as the scheme assigning it the maximum priority (for example, 100) and applying it to all the spots in the affected region, in DB 164. As the event grows closer and planning details grow clearer, the blackout rule for the whole region can be gradually replaced by a set of rules which are geographically more specific and less exclusive to users wishing to park on the day of the event.

Where relevant, notices are sent to users (for example, subscribers and/or residents) informing them that their parking rights will be suspended for the day of the event.

Second Exemplary Use Scenario

Delivery trucks typically require oversized spots for short periods of time, for example, to load or unload merchandise. The oversized spots are typically required along known routes, at known locations and/or at a known schedule. To date, trucks stopping to load or unload typically extend into the street causing slowdown of cars and traffic congestion.

Referring to FIGS. 1 and 3, in some embodiments a truck registration number is entered through user client device 122 and the truck registration number is transmitted from the parking reservation server 120 to vehicle registration DB 162 as exemplified in flowchart 1300. In some embodiments the location of the truck may is known (e.g., based on GPS tracking of the user client device used for entering the truck registration number). Thus, based on location of the truck (e.g., when the location of the truck is proximate to a known loading or unloading location), at predetermined dates and/or hours during the day a pre-set additional size requirement is automatically employed 1355 for the truck registration number, resulting in calculation of an appropriately sized parking spot 1330 and automatic reservation 1340 of the spot, typically for a limited predetermined time period.

This feature enabled by methods and systems according to embodiments of the invention allows for suitable parking spots for trucks thereby contributing to a reduction in eliminating traffic congestion.

Third Exemplary Use Scenario

Referring now to FIG. 7c, in some embodiments business places want to reserve large enough parking spots near the business place for delivery trucks. According to these embodiments the owner of the store or other business subscribes to several contiguous parking sub units at the front of the store, for example, sub units 1730, 1731 and 1732, for certain days and for certain time slots on those days.

Fourth Exemplary Use Scenario

Venues such as sport stadiums typically have large parking areas which are filled to capacity during a sports event at the stadium but which are relatively empty at other times.

In some embodiments in order to provide more efficient utilization of a venue parking area, CCC 151 (FIG. 1) applies a rule of low rates or even free parking to all parking spots (or parking subunits) in the stadium area when there is no event in the stadium. In another embodiment the venue parking area is, when there is no sports event, as a park & ride area (transportation hub) with shuttles running from the parking area to a regional or city center. According to these embodiments, a parking spot in the venue parking area is suggested to drivers on the UI of user client device 122 in response to a user entering a destination in the city center.

During an event or typically a predetermined time prior to the event a rule change is applied to all spots in the stadium parking area through rule DB 166. According to various exemplary embodiments of the invention the rule change includes an increase in price and/or a limit on allowed parking duration. Alternatively or additionally, system 100 offers a discount for advance reservations for event parking, which reservations are stored at spot DB 164.

Exemplary Enforcement Considerations

Although many users might normally be reticent to inform on a vehicle that is guilty of a parking violation, system 100 encourages, or even requires, them to do so if an unauthorized vehicle is parked in a spot reserved for them. Spot reservation gives a sense of entitlement which makes reporting a violation seem more acceptable. Alternatively or additionally, if an unauthorized vehicle is parked in a spot reserved for a user, the user needs to report the event to the system in order to receive an alternate spot.

In some embodiments a user client device 122 is operated by a warden, for example, an officer of the municipality. The UI of a user client device 122 used by a warden may typically include a map or other representation of a region showing available and non-available parking spots or subunits. A warden may be referred to specific parking spots through violation system 130 and/or the warden may identify violations by comparing the map on his user client device 122 to the actual situation on-site.

Exemplary Backup Considerations

In some exemplary embodiments of the invention, for example when system 100 is applied to a region such as a municipality which is transitioning from a current or default status in which municipal parking rules are posted on signs or painted on pavements and/or curbs the computerized system of FIG. 1 overrides the previously installed visual instructions, so long as the system is functioning. In some embodiments as long as the various communications networks of system 100 are in working order, then the only way to legally park in the city is through system 100.

In case of a failure of system 100, or a component communications networks, or other operational component, predetermined default parking rules are available to all.

For example, signs and painted markings may apply when the system is down (This is analogous to a stop sign at an intersection with a traffic light; the stop sign is in position for times when the traffic light does not function).

Alternatively or additionally, system 100 includes a backup database storing the city's “default” settings for each parking spot in a downfall situation. In some embodiments “default” settings are available for download to a user client device for future use. Alternatively or in addition printed maps of the city's “default” settings may be posted on billboards, or in the printed or electronic media, and the like.

After the system is back “up” a grace period is permitted in which cars that parked according to the default settings are not ticketed.

Additional Exemplary Considerations

In some embodiments system 100 includes a queue management module managing (DB 172 in FIG. 1) a queue of parking requests. In some embodiments parking requests are prioritized based on different parameters as described herein. In one embodiment parking requests are prioritized based on a user's (e.g., driver's) reputation. In some embodiments a driver's reputation is saved as part of a user profile. For example, in some embodiments a driver (represented by their user client device, e.g., UCD 122a) that repeatedly violates is given negative points by the queue management module whereas drivers that abide by the rules are given positive points. Alternatively or additionally, in some embodiments a driver's reputation is based on the amount of positive and negative points accumulated in the queue management module. In one embodiment a user's reputation is used to change the priority of a parking request in a queue, e.g., to offer better conditions (e.g., less waiting time) to a driver having more positive points and/or offer worse conditions to a driver having more negative points.

In some embodiments a warden is given a suggested route to check for violations using a map provided to the warden from CCC 151 (FIG. 1). In some embodiments system 100 adjusts itself to “add” notifications when additional violations occur along the route and/or generate new routes which incorporate newly registered violations. In some embodiments, this feature contributes to an increase in the number of citations/unit time from a single warden.

In some embodiments method 2700 (FIG. 7a), includes providing suggested routes to a warden, e.g., the most efficient route for the warden to walk (or otherwise travel) to a parking spot of interest. Parking spots of interest include, for example, parking spots due to expire in 5; 10; 15 or 20 minutes or smaller or intermediate periods of time and/or parking spots where a violation has been reported and/or other parking spots where a warden's checkup is desired.

Alternatively or additionally, in some embodiments the suggested route is based on a known location of the warden (e.g., based on the GPS location of the warden's user client device 2800 (FIG. 7b)) and/or based on known locations of parking spots of interest.

In some exemplary embodiments of the invention, a warden is assisted by camera based or other sensors located and positioned along streets and other parking areas to monitor parking spots (e.g., by detecting and recording vehicle license plate numbers using OCR technology). In some embodiments a warden uses the information provided by the camera and/or sensors to report status changes of parking spots and/or violations. Alternatively or additionally, in some embodiments a route is suggested to the warden (as described above) based on the information provided by the sensors. In some embodiments the suggested route is based on a known location of the warden (e.g., based on the GPS location of the warden's user client device 2800 (FIG. 7b)) and/or based on known locations of parking spots of interest.

In some embodiments a status of specific parking spots is updated in DB 164 (e.g., from “occupied” to “available”) based on reports from user client devices (such as devices 122a or device 2800). In some embodiments the status of specific parking spots is updated in DB 164 based on input from a sensor located and positioned along streets and other parking areas to allow monitoring of parking spots. According to various exemplary embodiments of the invention the sensors include cameras and/or RFID tags located at each parking spot or parking subunit. For example, in some embodiments RFID tags are integrated into pavements or roads at each parking subunit. According to these embodiments, RF readers in vehicles allow system 100 (FIG. 1) to identify vehicles (specifically which vehicles) that have entered or exited specific parking spots. Alternately RFID tags are located in vehicles and RF readers are located at parking spots.

In some embodiments method 3700 includes receiving 3740 a confirmation of parking in a reserved spot and/or of exiting a reserved spot based on input from a sensor monitoring the spot, such as an RFID sensor capable of communication with the system.

In some embodiments parcels of land or parking subunits are marked by painted markings (such as lines demarcating each parking subunit) on pavements or roads. Alternatively or additionally, in some embodiments other markings are used (e.g., in geographical regions suffering from harsh weather such as snow and fog), such as sign posts or other appropriate techniques.

In some embodiments, in order to facilitate identification of a parking spot, numbers or other identifying characters are placed adjacent to the end of the lines demarcating each parking subunit. Sidedness may be indicated for example by the addition of “L” or “R” to the identifying characters, based on which side of the road the parking spot is located. In some embodiments each marking has an adjacent color painted (or otherwise applied) on the pavement/street. In some embodiments the colors appear in a fixed sequence (eg. RGB—Red, Green Blue). Alternatively or additionally, in some embodiments each identifying character (or group of characters) has a corresponding color thereby making it easier to identify a parking spot (e.g., trying to identify a spot composed of subunit 244 Green or 42 Blue). Alternatively or additionally, in some embodiments different sided sidewalks are painted in a different color or numbered (e.g., odd/even), facilitating identification of parking spots.

In some embodiments privately owned spots, or other off-street parking subunits are marked with similar markings as on-street parking subunits to facilitate identification of all parking spots within system (e.g. system 100).

According to some embodiments of the invention privately owned spots, or other off-street parking subunits or spots are included in system 100, thereby enabling enforcement (e.g., by wardens) and other advantages of the system in privately owned and other off-street parking spots for the benefit of the off-street parking spot owners.

Alternatively or additionally, in some embodiments system 100 is backed up by mirroring servers and/or DBs in different location. If one of the servers crashes, incoming communications from UCDs 122 are directed to the mirror.

In some embodiments, in case of failure or shutdown of the entire system including backups a procedure is initiated in which user client devices 122 are notified and are requested to manually switch or are automatically switched to off-line mode. According to these embodiments, off-line mode devices receive parking rules and/or a driver parks using default parking rules. In some cases additional features are provided. Additional features in this context include, but are not limited to billboards advising drivers of parking rules during system failure.

In some embodiments drivers continue to report arrival at a reserved parking spot and/or exit from the parking spot in offline mode. According to these embodiments offline mode reports are stored on the user client devices 122. Once system 100 is back up, reports stored in user client devices 122 are uploaded to system 100 and server 120 updates event history DB 168 with offline mode parking events. In some cases, by statistically analyzing the events (based on history analytics), the system determines how many events should have occurred and also how many were reported, thereby deriving the percent of “unreported” events. In some embodiments the unreported events are accommodated by increasing an occupancy buffer to handle larger margins of error (e.g., if it is determined that only 80% of the actual parking events were reported, 20% extra free spaces can be left open to allow reallocation for people requesting spots that were occupied).

In some embodiments in case of failure of data networks providing communication between UCDs 122 and server 120 (which may effect for example 3G based user client devices), users park using unaffected functions of their devices, such as by using SMS messaging and/or Interactive voice response (IVR) and/or unaffected devices such as kiosk 900 (FIG. 9) or devices at call centers.

Alternatively or additionally, in some embodiments in case of failure of phone networks drivers park using devices such as kiosk 900 (FIG. 9) or warden's devices.

Alternatively or additionally, in some embodiments basic vehicle details such as size and color may are pre-stored on user client device 122 to be used in case of failure of a DB at an external licensing authority from which vehicle DB 162 receives information regarding vehicle attributes. In some embodiments vehicles parking for the first time during failure of an external licensing authority DB are required to enter one or more details (e.g., by choosing a vehicle size from a list of several, e.g., 3 size categories and color from a list of colors) in order to reserve parking via system 100.

Alternatively or additionally, in some embodiments in case of failure of a navigation system associated with a user client device 122, a driver uses maps available from kiosk 900 (FIG. 9) or another navigating systems or is directed by an operator at a call center.

Alternatively or additionally, in some embodiments in case of failure of payment methods operated by user client device 122, payment is achieved by other methods such as by paying at a kiosk 900 (FIG. 9) or by mail.

It is expected that during the life of this patent many new types of user client devices and/or communications networks will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as separate items/individual actions may be combined into a single item/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

More specifically, the features described in the context of FIGS. 1, 3, 4, and 5a are interchangeable among those systems and the user interface features presented in FIGS. 2a, 2b and 2c, 5b and 5c are employed in any or all of those systems in various embodiments of the invention.

Each recitation of an embodiment of the invention that includes a specific feature, part, component, module or process is an explicit statement that additional embodiments of the invention not including the recited feature, part, component, module or process exist.

Specifically, the invention has been described in the context of parking but might also be used as a traffic control system.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A system comprising:
(a) a reservation server receiving reservation input, parking confirmation input and parking exit input from at least one user client device; and
(b) a parking spot status database in communication with said server and configured to assign to each spot in said database a status selected from a group comprising at least available, reserved and occupied in accord with said inputs received by said server.

2. A system according to claim 1 comprising:
(c) a mapping engine adapted to produce map output data for each spot.

3. A system according to claim 1 comprising:
a reservation nesting module adapted to identify incoming reservation inputs with a defined parking duration and match them with spots that have a current status of available and a reserved status at a time that is further in the future than a present time plus said defined parking duration.

4.-18. (canceled)

19. A system comprising:
(a) a database of individual parking spots, each of said individual parking spots associated with a unique identifier (UID) and location coordinates;
(b) at least one computer workstation adapted to display a map;
(c) a graphical user interface (GUI) operable on said workstation, said GUI adapted to receive a map area selection as a first input and at least one usage statistic as a second input; and
(d) an analytic module adapted to produce an output status report including at least one usage statistic for said parking spots with location coordinates in said map area.

20. A system according to claim 19, wherein said at least one usage statistic indicates percentage of spaces currently occupied.

21. A system according to claim 19, wherein said at least one usage statistic indicates percentage of spaces currently reserved and current average reservation time.

22. A system according to claim 19, wherein said at least one usage statistic indicates percentage of spaces currently reserved for a future time and average reservation time for said future time.

23. A system according to claim 19, wherein said at least one usage statistic indicates percentage of spaces currently in violation of parking rules.

24. A system according to claim 19, wherein an output status report depicts one or more usage statistics as a function of time.

25. A system according to claim 19, wherein at least some of said individual spots are on street spots.

26. A system according to claim 19, wherein an output status report depicts one or more usage statistics based on different rules applied to said map area.

27. A system comprising:
(a) a database of individual on-street parking spots, and individual off-street parking spots, each of said individual parking spots associated with a unique identifier (UID) and location coordinates; and
(b) an off-street spot management module in communication one or more external client devices, the off-street spot management module adapted to receive parking rules for an individual parking spot from an external client device operated by an administrator of an individual parking spot.

28. A system according to claim 27, comprising: a location definition module adapted to receive location coordinates defining a specific individual off-street parking spot from one of said one or more external client device, assign a UID to said location coordinates to create an individual spot definition and add said spot definition to the spot database.

29. A system according to claim 27, comprising: a cue management module adapted to receive cue information related to a specific individual off-street parking spot and associate said cue information with said specific spot in a spot database.

30. A system according to claim 27, wherein said off-street spot management module resides on a reservation server.

31. A system according to claim 27, wherein said off-street spot management module resides on an external client device adapted to communicate with a reservation server.

32. A system according to claim 27, wherein at least some of said individual off-street parking spots are privately owned.

33. A system according to claim 27, wherein said off-street spot management module has a user interface selected from a web based interface and a smartphone based interface.

34.-35. (canceled)
